(19) United States
(12) Patent Application Publication
(10) Pub. No.: US 2024/0011666 A1
(43) Pub. Date: Jan. 11, 2024

(54) Cooling System

(71) Applicants: Nan Chen, Greenville, SC (US); He Zhao, Flagstaff Hill (AU); Yunshui Chen, San Ramon, CA (US)

(72) Inventors: Nan Chen, Greenville, SC (US); He Zhao, Flagstaff Hill (AU); Yunshui Chen, San Ramon, CA (US)

(21) Appl. No.: 18/338,217

(22) Filed: Jun. 20, 2023

Related U.S. Application Data
(60) Provisional application No. 63/359,739, filed on Jul. 8, 2022.

(51) Int. Cl. F24H 1/20; G06F 1/20

(52) U.S. Cl. CPC F24H 1/208; G06F 1/20; F24H 2250/00

(57) ABSTRACT

A system is provided for cooling the heat generated by a miner, the system includes a liquid cooling chassis comprising a miner and a dielectric fluid enclosure and a water tank kit for storing water, the water tank kit includes a coil with said dielectric fluid, wherein the heat generated from said miner is transferred to the water stored in said water tank kit by pumping the heated dielectric fluid from the liquid cooling chassis into the coil in the water tank kit to produce a heat source thereof.

### CROSS-REFERENCE TO RELATED APPLICATIONS

The present Utility patent application claims priority benefit of the U.S. provisional application for patent Ser. No. 63/359,739 entitled “Cryptocurrency miner boiler” filed on 8 Jul. 2022, under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to heat recovery in IT applications. More particularly, certain embodiments of the invention relate to heat recovery systems configured to recover thermal energy from heat generating IT applications.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It is believed that the computing power used in typical cryptocurrency mining systems may result in the consumption of large amounts of energy and the generation of a great deal of heat. As an example, the University of Cambridge estimates that 231.7 gigawatt-hours are required to fuel one day of Bitcoin mining, while a whole year of mining consumes about 84.6 terawatt-hours. Finding a way to reuse this amount of energy could provide many beneficial effects. Regarding cooling technologies applied in cryptocurrency miners, air-cooled fans plus heat sinks take the majority of market shares currently. In such air-cooled solutions, the thermal energy up to 90° C. from the chips is typically dissipated into the ambient environment directly with typically no chance for recovery because of the poor heat transferring coefficient between the heat sink and the air. In recent years, engineers have paid attention to improving the heat transferring efficiency in different ways, such as liquid cooling (direct or indirect liquid cooling), cold plate cooling, microchannel heat sinks, and so on. However, it is believed that there have been limited efforts to recover the thermal energy generated by the electric device (i.e., cryptocurrency miner).

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a graph of testing results indicating the relationship between miner power, hash board temperature, running frequency, and coolant temperature, in accordance with an embodiment of the present invention;

FIG. 2 is a schematic diagram of an exemplary heat recovery system, in accordance with an embodiment of the present invention;

FIG. 3 is a schematic diagram of an exemplary heat recovery system comprising one miner liquid cooling chassis, in accordance with an embodiment of the present invention;

FIG. 4 is a schematic diagram of an exemplary heat recovery system comprising two miner liquid cooling chassis and a secondary water tank kit, in accordance with an embodiment of the present invention;

FIG. 5 is a schematic diagram of an exemplary heat recovery system comprising one an open expansion tank kit, in accordance with an embodiment of the present invention;

FIG. 6 is a schematic diagram of an exemplary heat recovery system comprising designed for storage volume, in accordance with an embodiment of the present invention;

FIG. 7 is a schematic diagram of an exemplary heat recovery system comprising one miner liquid cooling chassis, in accordance with an embodiment of the present invention;

FIG. 8A illustrates a front exterior view of an exemplary digital boiler based on a basic version of a heat recovery system, in accordance with an embodiment of the present invention;

FIG. 8B illustrates a right-side view of the exemplary digital boiler with a top shell removed, in accordance with an embodiment of the present invention;

FIG. 8C illustrates a left side view of the exemplary digital boiler with the top shell removed, in accordance with an embodiment of the present invention;

FIG. 8D illustrates a rear view of the exemplary digital boiler with the top shell removed, in accordance with an embodiment of the present invention; and

FIG. 8E illustrates a transparent right-side view of the exemplary digital boiler, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to, nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. At 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20^{th} Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said, “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred, or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. Or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):
“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).
“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.
“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes “of claim support and construction for ““consisting of” format cl”Ims, such replacements operate to create yet other alternative embodiments ““consisting essentially o”” only the elements recited in the original ““comprising”” embodiment to the exclusion of all other elements.

Moreover, any claim limitation phrased in functional limitation terms covered by 35 USC § 112(6) (post AIA 112(f)) which has a preamble invoking the closed terms ““consisting of”” or ““consisting essentially of”” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s). Furthermore, any statement(s), identification(s), or reference(s) to a structure(s) and/or element(s) that corresponds to and/or supports a claim limitation(s) phrased in functional limitation terms covered by 35 USC § 112(6) (post AIA 112(f)) should be understood to be identified by way of example and not limitation, and as such, should not be interpreted to mean that such recited structure and/or element is/are the only structure(s) and/or element(s) disclosed in this patent application that corresponds to and/or supports such claim limitations phrased in functional limitation terms. This claims interpretation intention also applies to any such subsequent statements made by Applicant during prosecution.

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms ““couple”” and ““connected”” along with their derivatives, may be used. It should be understood that these terms are not intended as synonyms for each other. Rather, in particular embodiments, ““connected”” may be used to indicate that two or more elements are in direct physical or electrical contact with each other. “Couple”” may mean that two or more elements are in direct physical or electrical contact. However, “couple”” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Embodiments of the present invention disclose systems that may be used to recover heat generated by cryptocurrency miners that are cooled by immersion/spray liquid cooling technologies, such as those described in a previously submitted patent application by the applicants. Preferred embodiment may comprise boilers for recovering the thermal energy from cryptocurrency mining, which may be implemented as hot water tanks with embedded coils, thermostats, circulation pumps and other accessories integrated into a complete system to work as independent or addon heat sources. Some preferred embodiments may utilize dielectric fluid driven by a pump and circulated between the water tank and cryptocurrency miners as a heat transfer medium. Such embodiments may be implemented with immersion or spray cooling technologies, which are adaptive. Dielectric fluid as a heat transfer medium is used in preferred embodiments. The properties of a suitable dielectric fluid may be chosen based on the properties required for the particular system including, but not limited to, breakdown voltage, which can make sure the electrical parts work properly in direct contact with the fluid, oxidation stability, which is the index of its anti-oxidization capability/stability to prevent the metal on the PCB or processors from being corroded by the products of oxidization, and viscosity, which is a key parameter to pump selection.

It is contemplated that some embodiments may be configured to provide full usage of the heat recovered from cryptocurrency miners for water heating and space heating. Such embodiments may function as an addon heat source of the current system or independently as a heat source. It is further believed that some embodiments may provide high-grade heat recovery of higher than 65° C. from cryptocurrency miners, which is above the temperature threshold of sanitary/space heating application. Based on immersion/spray liquid cooling technology, the maximum coolant outlet temperature can be up to 70° C., which meets universal requirements of sanitary water & space heating. ASHRAE guidelines require hot water to be stored at or above 140° F. (60° C.), hot water to be delivered at or above 124° F. (51° C.), and cold water to be stored at or below 68° F. (20° C.). It is believed that achieving as high as 60° C. is a solid threshold for engineers to realize the heat recovery from cryptocurrency miners.

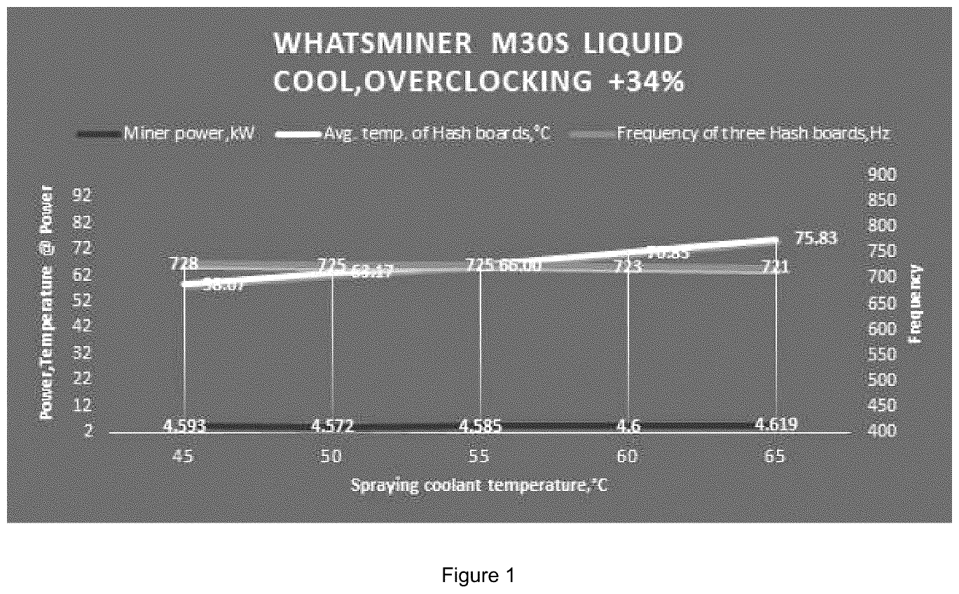

FIG. 1 is a graph of testing results indicating the relationship between miner power, hash board temperature, running frequency, and coolant temperature, in accordance with an embodiment of the present invention. These testing results found that the 75.83° C. hash board temperature could be achieved by cooling with inlet coolant temperature at 65° C., suggesting that immersion/spray liquid cooling technologies may be applied to cryptocurrency mining boilers as a high-efficiency heat transferring technology. In the testing this configuration broke through the temperature barrier of 60° C. of conventional liquid cooling heat recovery technologies. Thermal energy recovered from cryptocurrency miners is theoretically close or equal to its power input. One may expect that this merit together with the benefits from cryptocurrency trade may result in this technology being a more economically competitive option than conventional electrical heating solutions like conventional electrical water heaters and space heaters. Some modern chips in cryptocurrency miners can work stably at 135° C. chip temperature and 90° C. PCB temperature, which are high enough temperatures for residential/commercial hot water and space heating. One may expect that the higher the coolant temperature can be elevated to be closer to PCB or Chip temperature limits, the more high-grade thermal energy can be recovered, which may make the thermal energy more suitable to be recovered by advanced heat transferring enhancement technology.

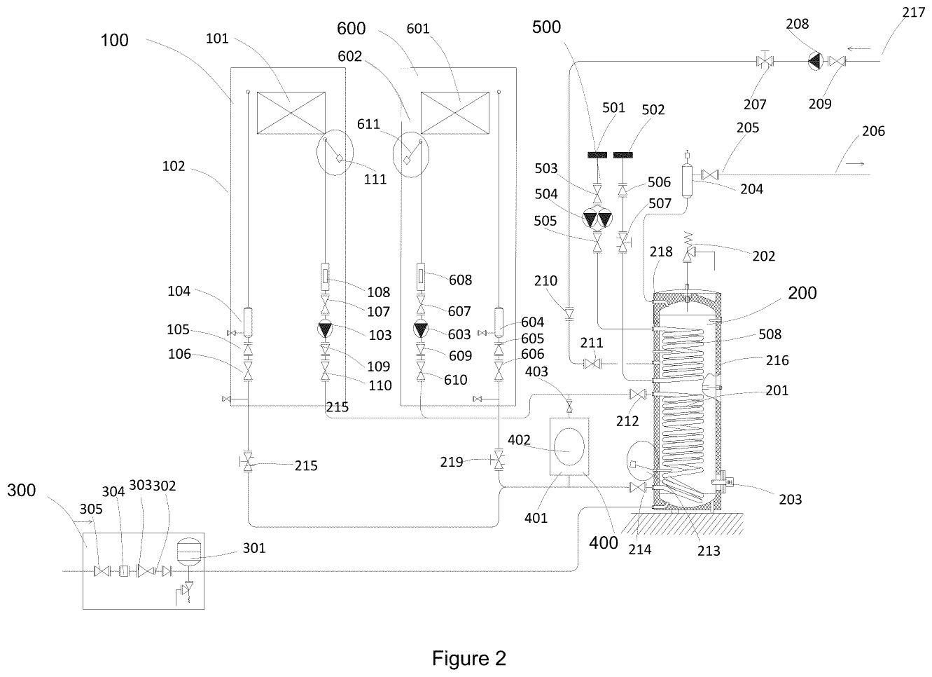

FIG. 2 is a schematic diagram of an exemplary heat recovery system, in accordance with an embodiment of the present invention. In the present embodiment, the system comprises five major kits, miner liquid cooling chassis 100 and 600, a water tank kit 200, a water replenishing kit 300, a dry cooler 400, and a secondary fluid circle 500. A miner 101 is housed within an enclosure 102 connected to the water tank kit 200. The thermal energy generated from the miner 101 heats a dielectric fluid within a line going to the water tank kit 200. The heated dielectric fluid is then suctioned into a pump 103 through a sight glass 108 and an isolation valve 107. The heated dielectric fluid exits pump 103 and flows through a check valve 109 and an isolation valve 110 into the line connected to a coil 201 in a water tank 216. Sight glass 108 may be used by a maintenance person such as, but not limited to a service engineer to check the status of the fluid in the tube. Isolation valve 107, 110 isolates pump 103 from 100 miner liquid cooling chassis when service or replacement is required, and prevents the dielectric fluid flooding out of 100 miner liquid cooling chassis. A liquid level control valve 111 detects the level of dielectric fluid in the internal volume of enclosure 102. If the liquid level is too low, an alarm is triggered, and the system may be stopped.

At the water tank 216, isolation valves 212 and 214 can isolate the dielectric fluid in the internal volume of coil 201. For example, without limitation, isolation valves 212 and 214 may help in reducing or avoiding leakage from coil 201. Also, when the water tank kit 200 has to be replaced, isolation valves 212 and 214 may work together with isolation valves 211, 505, and 205 and regulation valve 507 to isolate water tank kit 200 from the rest of system. The internal volume of water tank 216 is filled with fresh water from water replenishing kit 300, and the water in the water tank 216 is heated by the heated dielectric fluid in coil 201 and is then pushed out to a water supply line 206 through a water outlet port 218. The water supply line 206 may provide hot water to an outlet or faucet for use or could circulate through a heating element (e.g., a radiator) to provide radiant heat, for example, without a radiator On the water supply line 206, an air purger 204 can discharge any air released from water into the ambient environment. Isolation valve 205 enables the flow of water to external pipelines to be isolated. If the system is configured for return water, a return water line 217 may enable water returning to water tank to be suctioned by water pump 208 and pumped into the internal volume of the water tank 216. Some embodiments, for example, without limitation, those configured to only provide hot water for consumption or use, may be implemented without a return water line. An isolation valve 209 can isolate this circuit from the external pipelines. A regulation valve 207 can regulate the flow of water from pump 208. An isolation valve 211 on return waterline 217 can isolate the return water line 217 from water tank 216. A check valve 210 generally ensures the one-way flow from water pump 208 to the internal volume of water tank 216. A relief valve 202 protects the system from the over pressurization of the water tank 216 by hot water. A thermostat 203 on water tank 216 detects the water temperature in water tank 216 and controls the opening of a flow control valve 403. The flow control valve 403 can lead the flow of dielectric fluid through a dry cooler coil 401 to reduce the flow through coil 201. As a result of reducing the flow through coil 201, the percentage of heat rejected in coil 201 decreases. Dry cooler 400 comprises coil 401 and a fan 402 which circulates airflow over the surface of coil 401 to cool it. The dielectric fluid driven by pump 103 partially flows through coil 401. The flow of dielectric fluid through coil 401 may be controlled by adjusting flow control valve 403. For example, without limitations, when valve 403 is fully opened, the dielectric fluid completely flows through coil 401 which may be the same mass flow out of pump 103 and 603 or may partially depend on the ratio of pressure drop between coil 401 and coil 201. Further, the ambient heat rejected may be controlled by controlling valves 403 and 212. For example, without limitations, when water temperature catches the setting point, less dielectric fluid will go to coil 201, and more will flow into coil 401, by which extra heat can be dissipated into the ambience by coil 401, and temperature will be under control. Further, valve 212 may be automatically turned off when the water temperature is high, thereby enable the dielectric fluid to fully flow through coil 401. Dry cooler 400 may be controlled by thermostat 203 to maintain the water temperature at a stable point as requested by the customer, while also ensuring suitable working conditions for mining. A liquid level controller 213 detects the liquid level in the water tank 216 and controls the replenishing of water from water replenishing kit 300. Water replenishing kit 300 is a conventional water replenishing design including a check valve 302, two isolation valves 303 and 305, a filter 304, and an expansion tank 301.

In the present embodiment, secondary miner liquid cooling chassis 600 is a duplicate part of miner liquid cooling chassis 100. Their design and configurations are a standardized/modulized design. Miner liquid cooling chassis 100, 600 comprises a miner 101, 601, a pump 103, 603, a filter 104, 604, a check valve 105, 605, isolation valves 106, 606 and 107, 607, a sight glass 108, 608, a check valve 109, 609, an isolation valve 110, 610 into the water tank line, and a liquid level control valve 111, 611 all housed in an enclosure 102, 602, respectively. The function of filter 104, 604 is to keep the system clean and avoid blockage. Filter 104, 604 removes dirt from the electronic devices washed out by dielectric fluid. In some embodiments, the tags and labels in electronic devices are also washed out. Check valve 105, 605 enables to check if the dielectric fluid is flowing along the correct direction. In some embodiments, check valve 105, 605 is optional. Isolation valve 106, 606 isolates filter 104, 604 and check valve 105, 605 during repair or replacement services. Miner liquid cooling chassis 100 and 600 are in parallel and double the heating capacity linearly by increasing the number of heat sources. By adjusting a primary chassis regulation valve 215 and a secondary chassis regulation valve 219, hydraulic balance can be achieved between mining chassis 100 and 600.

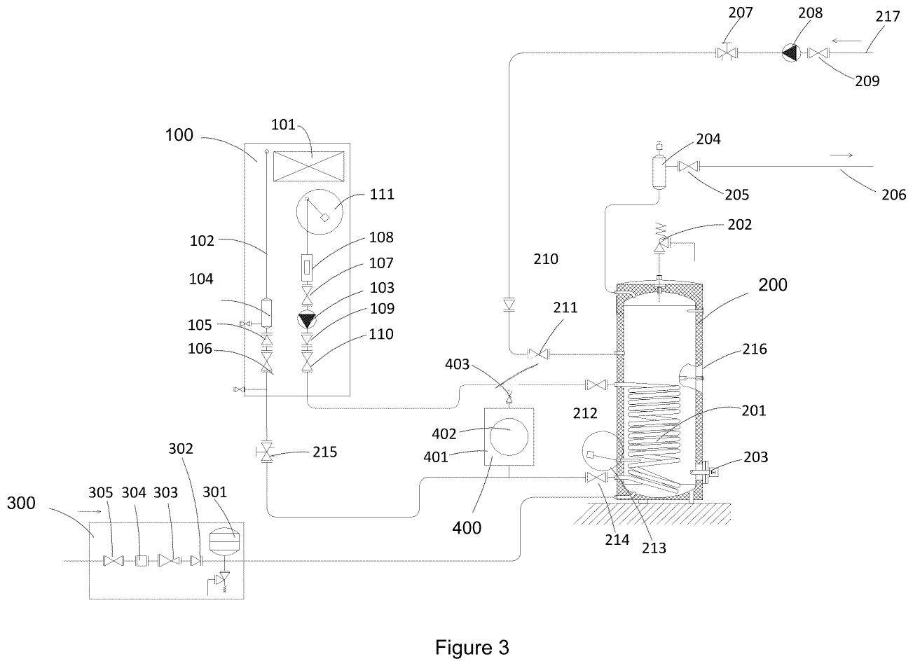

The parts in the secondary fluid circle 500 in order by the sequence of fluid flowing are a secondary return water port 501, an isolation valve 503, a pump 504, an isolation valve 505, a secondary coil 508, a regulation valve 507, a check valve 506, and a secondary supply water port 502. Secondary fluid circle 500 can be used for two different purposes, as a secondary/auxiliary heat source to heat the water in the water tank 216 or as a secondary/auxiliary heat sink to cool the water in the water tank 216. To be a secondary/auxiliary heat source, the fluid in fluid circle 500 is at a higher temperature than that of the water in water tank 216. There are two different conditions/functions of fluid circle 500. When the heat capacity from mining chassis 100 and 600 is less than the heating capacity demands from water line 206, hot fluids from extra heat source can be supplied through port 501 and return through port 502. This extra heat source can be heat pump, boiler or electrical heater working as booster. When the fluid temperature in the fluid circle 500 is lower than water temperature in water tank 216, the fluid in fluid circle 500 will be heated as a heat sink. The fluid in fluid circle 500 is isolated with the water in the water tank 216. The benefit is that the fluids in fluid circle 500 other than water can be heated directly avoiding the corrosion to the water tank 216, e.g., the fluid containing high amounts of calcium and magnesium. The water in the water tank 216 can be heated by coil 201 as the primary heating stage and coil 508 as the secondary heating stage to achieve high temperature water as requested. This hotter fluid goes into the secondary return water port 501 and is suctioned by the pump 504 through the isolation valve 503. The hotter fluid is then pumped into the secondary coil 508 to heat the water enclosed in the internal volume of water tank 216 further. The fluid in fluid circle 500 can be the same or different fluid to the fluid in the internal volume of water tank 216, and the two fluids are completely separated by the coil 508, which makes it possible to suit different secondary heat sources or special requirements of supply water. Alternatively, fluid circle 500 can work as a heat sink to absorb heat energy from the water in the water tank 216. In this situation, the fluid in fluid circle 500 has a lower temperature than the water in water tank 216 and could be any fluid as requested since it is separated from the water in the water tank 216 by coil 508. The use of secondary fluid circle 500 as a secondary/auxiliary heat source or a secondary/auxiliary heat sink may be customized based on user's temperature or power requirement. FIG. 3 is a schematic diagram of an exemplary heat recovery system comprising one miner liquid cooling chassis 100, in accordance with an embodiment of the present invention. The system described here comprises many of the same components as the embodiment described in reference to FIG. 2, but these two embodiments differ in the number of modules or kits within the system. In the present embodiment, the heat recovery system comprises four major kits, liquid cooling chassis 100, a water tank kit 200, a water replenishing kit 300, and a dry cooler 400. A miner 101 is located in an enclosure 102 with a dielectric fluid. As the miner 101 runs, the thermal energy generated from the miner 101 heats the dielectric fluid in the enclosure 102 which is suctioned into a pump 103 through a sight glass 108 and an isolation valve 107. The heated dielectric fluid exiting pump 103 flows through a check valve 109 and an isolation valve 110 into the line connected with a coil 201 in a water tank 216. A liquid level control valve 111 detects the level of dielectric fluid in the internal volume of enclosure 102. If the liquid level is too low, an alarm is triggered, and the system may be stopped. Isolation valves 212 and 214 can isolate the dielectric fluid in the internal volume of coil 201. The internal volume of water tank 216 is filled with fresh water from water replenishing kit 300. The water in the water tank 216 is heated by coil 201 and pumped out of water tank 216 to a hot water supply line 206 through a water outlet port 218. On the water supply line 206, an air purger 204 can discharge any air released from the water into the ambient environment. An isolation valve 205 can isolate the water flow from the external pipelines. The return water, if there is a return water supply, returns via a return water line 217 and is pumped into the internal volume of the water tank 216 by a water pump 208. An isolation valve 209 can isolate this circuit with the external pipelines, and an isolation valve 211 can isolate the return water line 217 from water tank 216. A regulation valve 207 can regulate the flow out of water pump 208. A check valve 210 can generally ensure the one-way flow from water pump 208 to the internal volume of water tank 216. A thermostat 203 can detect the water temperature in water tank 216 and control the opening of a flow control valve 403. The flow control valve 403 can regulate the flow of dielectric fluid through a dry cooler coil 401 to reduce or increase the flow through coil 201. When the flow is reduced, the percentage of heat rejected in coil 201 decreases. Dry cooler 400 comprises coil 401 and a fan 402 which circulates airflow over the surface of coil 401 to cool it. The dielectric fluid driven by pump 103 partially flows through coil 401. A chassis regulation valve 215 may be configured to balance inlet flow between two tanks. Further, by adjusting the opening of chassis regulation valve 215 a specific mass flow to individual tanks in accordance with the demand of heat load may be regulated. Chassis regulation valve 215 enables distribution of dielectric fluid into the tanks based on the heat load of electronic device that is present inside. A liquid level controller 213 can detect the liquid level in the water tank 216 and control the flow of replenishing water from water replenishing kit 300. Water replenishing kit 300 is a conventional water replenishing design including two isolation valves 303 and 305, a filter 304, a check valve 302, and an expansion tank 301. A relief valve 202 may help prevent over pressurization of the water tank 216 by hot water. The functions of filter 304, check valve 302 and isolation valves 303 and 305 are similar to the functions of filter 104, check valve 105 and isolation valve 106 as discussed above with reference to FIG. 2.

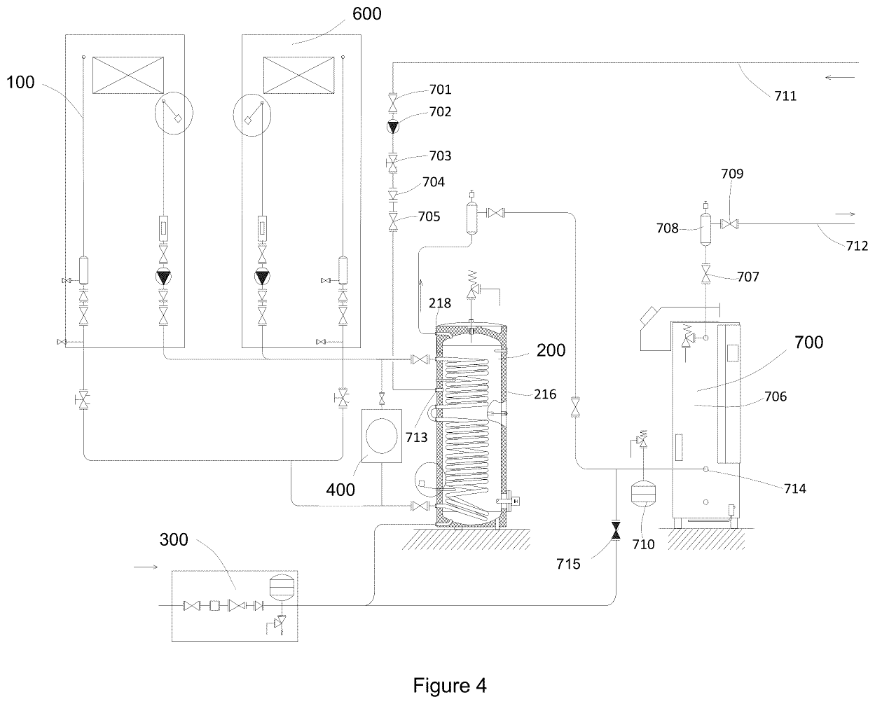

FIG. 4 is a schematic diagram of an exemplary heat recovery system comprising two miner liquid cooling chassis 100 and 600 and a secondary water tank kit 700, in accordance with an embodiment of the present invention. In the present embodiment, the system comprises many of the same components as the embodiment illustrated by way of example in FIG. 3 including, without limitation, miner liquid cooling chassis 100 and 600 and their respective components, a water tank kit 200 and its components, a water replenishing kit 300 and its components, and a dry cooler 400 and its components. However, there are points difference with between these two exemplary embodiments. For example, two parallel miner chassis 100 and 600 have been applied for higher heat capacity. Secondary water tank kit 700 works as an independent water tank and provides larger water storage volume, which can reduce the on/off cycling of the miners as heat sources and provide much more stable water flow/temperature. Return cold water from a return water line 711 passes through an isolation valve 701, a pump 702, an isolation valve 703, a check valve 704, and an isolation valve 705 in sequence into the internal volume of a water tank 216 through port 713. The hot water pushed out of the water tank 216 through a water outlet port 218 flows into a water tank 706 through a water inlet port 714. An expansion tank 710 before the inlet port 714 may be configured to 1. Absorb the expansion of the water in the tank 706 2. Maintain the pressure in the tank 706. Tank 706 provides a larger storage volume to handle load fluctuations in the system and is insulated to maintain the heat or to minimize heat losses. The tank 706 works as an extra water storage tank in the case of more storage volume required. It has to be insulated to reduce the heat losses. The tank 706 may be filled with fresh water from water replenishing kit 300, and an isolation valve 715 can isolate the flow of water to and from water replenishing kit 300. The water in the water tank 706 is pumped out through a hot water supply line 712. On the water supply line 712, an air purger 708 can discharge any air released from the water into the ambient environment. An isolation valve 707 can isolate the flow from the water tank 706, and an isolation valve 709 can isolate the water flow from the external pipelines.

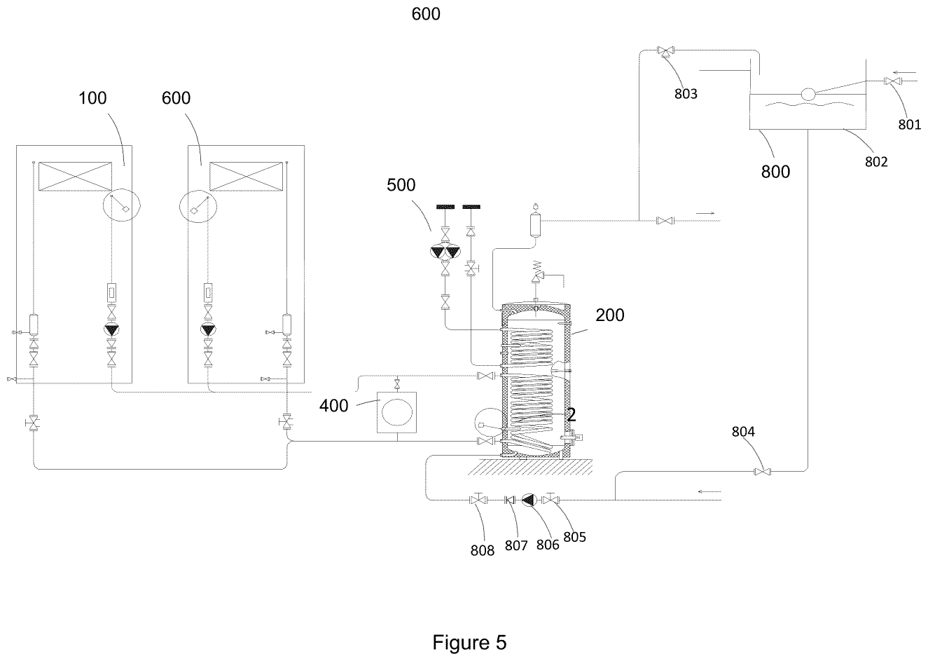

FIG. 5 is a schematic diagram of an exemplary heat recovery system comprising one open expansion tank kit 800, in accordance with an embodiment of the present invention. The present embodiment comprises miner liquid cooling chassis 100 and 600 and their respective components, a water tank kit 200 and its components, a water replenishing kit 300 and its components, a dry cooler 400 and its components, a secondary fluid circle 500 and its components, and open expansion tank kit 800. Open expansion tank kit 800 comprises, a water inlet valve 801, an expansion tank 802, overflow valve 803, isolation valves 804 and 805, a circulation pump 806, a check valve 807, and an isolation valve 808. The conventional expansion tank kit 800 takes the same functions as those done by a water replenishing kit in other embodiments. The replenishing water flows into the expansion tank 802 through the water inlet valve 801. The bottom of expansion tank 802 is connected with the suction side of circulation pump 806 to generally ensure a certain level of suction head to pump. Isolation valves 804, 805 and 808 may isolate various portions of the flow of water between expansion tank 802 and the water tank kit 200, and check valve 807 may help ensure the one-way flow from circulation pump 806 to the water tank kit 200.

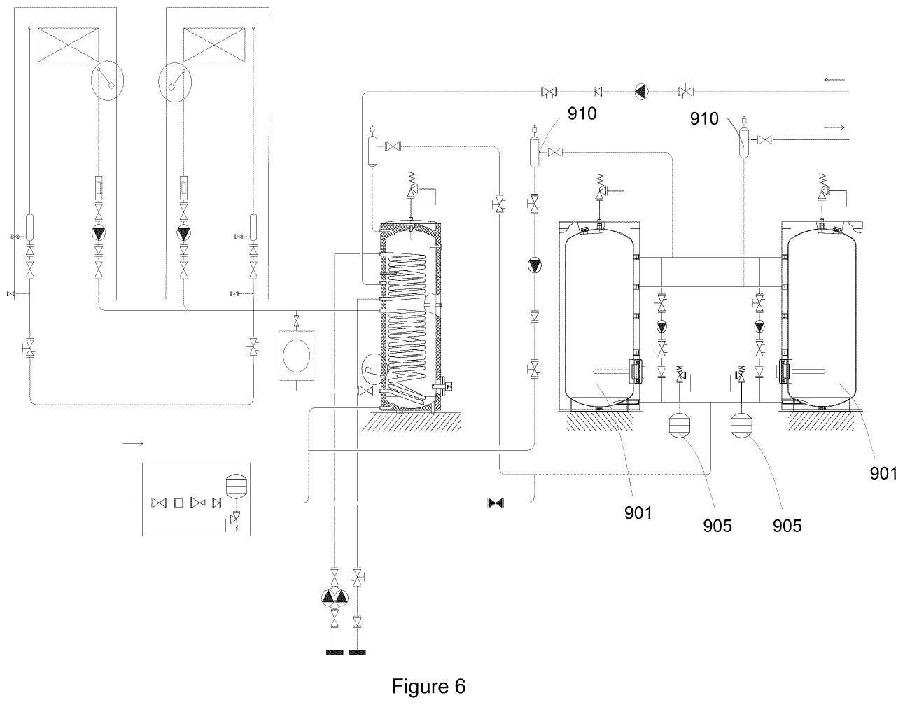

FIG. 6 is a schematic diagram of an exemplary heat recovery system comprising designed for storage volume, in accordance with an embodiment of the present invention. The present embodiment focuses more on the hot water supply/storage/return side, rather than heat sources side. Hot water reservoirs 901 with expansion tanks 905 and air purgers 910 are included in this configuration, which are placed in a mirror and can provide more storage volume of hot water.

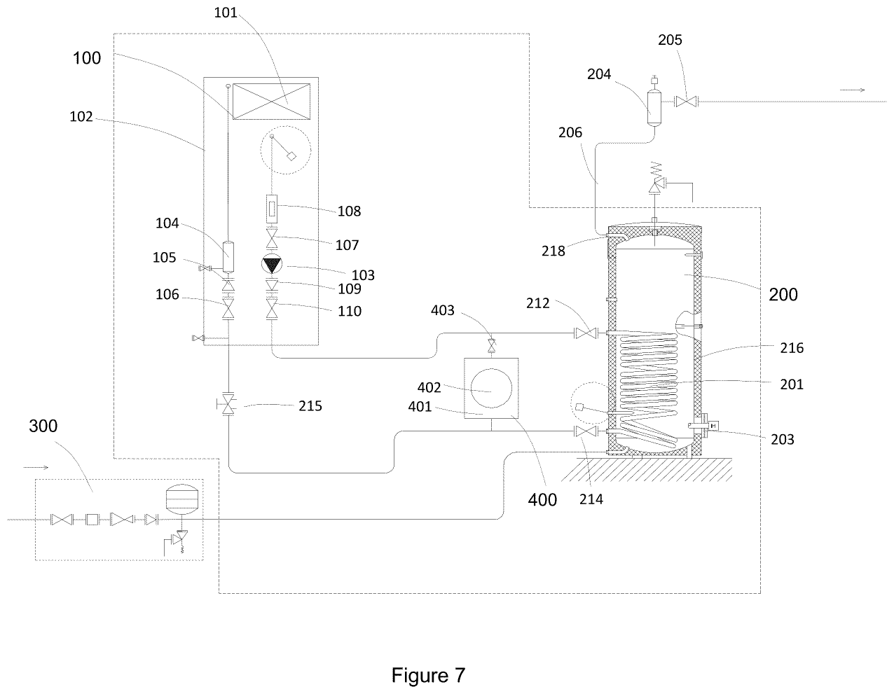

FIG. 7 is a schematic diagram of an exemplary heat recovery system comprising one miner liquid cooling chassis, in accordance with an embodiment of the present invention. This basic configuration comprises four major kits, a cooling chassis 100, a water tank kit 200, a water replenishing kit 300, and a dry cooler 400. The thermal energy generated from a miner 101 heats dielectric fluid in an enclosure 102. The heated dielectric fluid is then suctioned into a pump 103 through a sight glass 108 and an isolation valve 107. The heated dielectric fluid then exits pump 103 and flows through a check valve 109 and an isolation valve 110 into a line connected with a coil 201 in a water tank 216. Isolation valves 212 and 214 can isolate the dielectric fluid in the internal volume of coil 201. The internal volume of water tank 216 is filled with fresh water from water replenishing kit 300. And water in the water tank 216 is heated by the heated dielectric fluid in coil 201. The heated water from the water tank 216 may be pushed out to a water supply line 206 through a water outlet port 218. On the water supply line 206, an air purger 204 can discharge the air released from water into the ambient environment. An isolation valve 205 can isolate the flow with the external pipelines. A thermostat 203 can detect the water temperature in water tank 216 and control the opening of a flow control valve 403. The flow control valve 403 can lead the flow through a dry cooler coil 401 and reduce or increase the flow through coil 201. As a result, the percentage of heat rejected in coil 201 can decrease or increase. Dry cooler 400 comprises coil 401 and a fan 402 which circulates airflow over the surface of coil 401 to cool it. The dielectric fluid driven by pump 103 partially flows through coil 401. By adjusting the opening of chassis regulation valve 215 a specific mass flow to individual tanks in accordance with the demand of heat load may be regulated. Chassis regulation valve 215 enables mass flow of dielectric fluid into the tanks based on the heat load of electronic device that is present inside.

Those skilled in the art will readily recognize that the previously described embodiments are only some examples of configurations of systems that may be used to recover heat generated by cryptocurrency miners in accordance with the teachings of the present invention. It is contemplated that due to the modular nature of the kits (i.e., miner liquid cooling chassis, water tank kits, water replenishing kits, dry coolers, secondary fluid circles, open expansion tank kits) and additional components such as, but not limited to additional storages reservoirs a multiplicity of suitable configurations exist to achieve desired system parameters and objectives and to fit various different application circumstances. For example, without limitation, some embodiments may be implemented with many miner liquid cooling chassis for use in a large cryptocurrency mining facility. In some embodiments the system may be separated into a liquid cooling module and a water tank module that could be sold and installed separately and connected by pipes. Furthermore, virtually any heating process could incorporate an embodiment of the present invention as a pre-heating step if the required temperature is higher than 70° C. or as a primary heat source

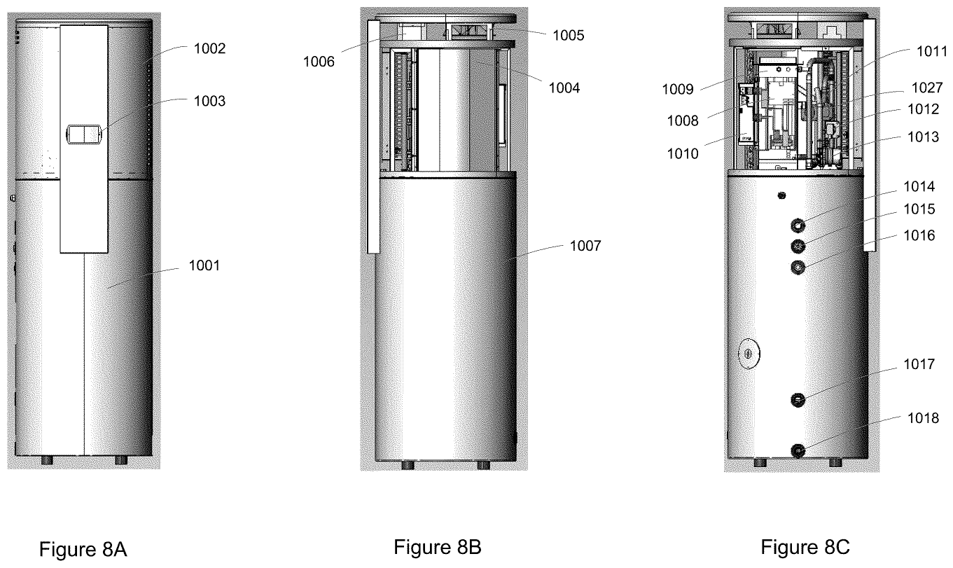

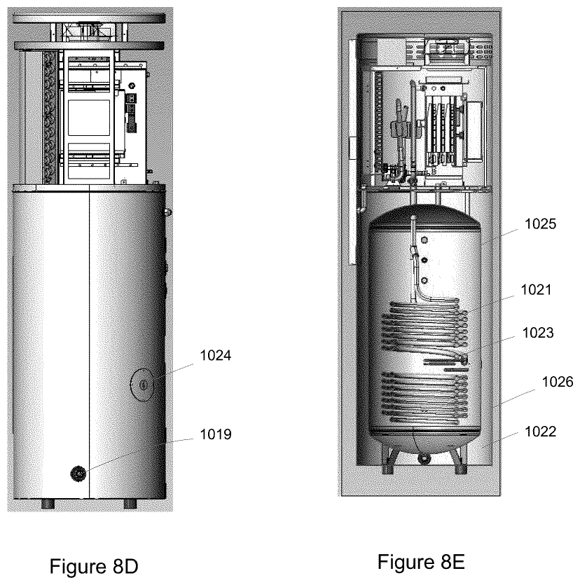

FIGS. 8A-8E illustrate an exemplary digital boiler based on a basic version of a heat recovery system, in accordance with an embodiment of the present invention. FIG. 8A is a front exterior view. FIG. 8B is a right-side view with a top shell removed. FIG. 8C is a left side view with the top shell removed. FIG. 8D is a rear view with the top shell removed, and FIG. 8E is a transparent right-side view. Referring to FIG. 8A, the digital boiler comprises three sections, a bottom section 1001, a top section 1002, and a controller 1003. The design of peripheral circulation circuits shown in the above system schematic diagrams depends on certain requirements and applications of the heating system. As the core of the heating system, a miner heater including one miner has been integrated with the hot water reservoir to provide basic functions (i.e., providing hot water) for the complex variations of the heating system. Referring to FIG. 8E, bottom section 1001 contains a tank 1007, a hot water drum 1025, a heat coil 2021, sensors, and connection ports. The parameters and features of bottom section 1001, such as, but not limited to volume, energy grade, and installation options can be selected flexibly according to an end user's requirements. Referring to FIG. 8B and FIG. 8C, top section 1002 acts as a heat resource and comprises a miner container 1009 enclosing a miner 1008, a pump 1013, power supply, a power switcher 1006, a heat exchanger 1004, solenoid valves 1011, 1012 and 1027, and a cooling fan 1005. Controller 1003 is the control panel for the digital boiler. Top section 1002 seats on the top of bottom section 1001, and both are enclosed in a sheet metal shell 1026, which can provide a certain level of protection. Bottom section 1001, top section 1002, and controller 1003 may be sealed for outdoor usage.

Referring again to FIG. 8B and FIG. 8C, top section 1001 contains a cryptocurrency miner 1008 enclosed in miner container 1009. All electrical connections including electrical power supply and internet cable may be provided in a terminal box 1010 to support the cryptocurrency mining. Power switcher 1006 may act as the power supply or control of fan 1005 and pump 1013. The heat rejected by cryptocurrency mining is carried out of miner container 1009 by a dielectric cooling fluid sprayed from the top of miner 1008 onto the surface of a heat sink attached to miner 1008. Fan 1005 may provide extra heat rejection capability to the ambient environment by pulling hot air from the digital boiler when the water temperature in a drum 1025 reaches a preset point. The solenoid valves 1011, 1012 and 1027 may be used to realize the function of bypassing the heat coil 1021 if the water temperature in the drum 1025 is higher than the set points and for bypassing the fan 1005 if the water temperature in the drum 1025 is lower or equal to the set points. The set points are temperature setting and is based on the user's preference. The bypass mechanism aids in maintaining the water temperature in drum 1025. Pump 1013 may be a long lift pump that can drive the dielectric fluid through the heat coil 1021.

Referring to FIG. 8C and FIG. 8D, the external portion of bottom section 1001 comprises a hot water supply port 1014, a temperature sensor 1015, a sacrificial anode 1016, a condensation drainage port 1017, a reservoir drainage port 1018, a cold-water port 1019, and an auxiliary heater port 1024. Referring to FIG. 8D and FIG. 8E, the interior portion of bottom section 1001 comprises heating coil 1021, an insulation layer 1022, an auxiliary heater 1023, and drum 1025. A function of bottom section 1001 is to store the hot water heated by the dielectric fluid from top section 1002. For example, without limitation, The dielectric fluid may include mineral oil or fluorinert. Drum 1025 may be located in the center of bottom section 1001 and may be wrapped in the insulation layer 1022. Drum 1025 may be built from stainless steel or another suitable material to provide corrosion resistance and possible materials for insulation layer 1022 include, without limitation, polyurethane foaming, neoprene, fiberglass, etc. Copper serpentine coils 1021 heat the water inside the drum 1025 by circulating the heated dielectric fluid from top section 1002. Sheet metal shell 1026 may be coated with plastic or paint for better weatherproofing. Cold water port 1019 may be located near the bottom drum 1025 to replenish the heated water that exits drum 1025 through the hot water supply port. 1014. The temperature in drum 1025 may be detected by the temperature sensor 1015 inserted into drum 1025. Sacrificial anode 1016 may be a magnesium or aluminum rod extended through interior of drum 1025 to attract particles of iron, limestone, or other minerals present in the water through an electrochemical process that may lead to corrosion in drum 1025. Condensation drainage port 1017 may be used to drain fluid collected in top section 1002, for example, without limitation, the rainwater can go into the top section 1002 through the opening of louver and fan, and reservoir drainage port 1018 may be used if the drum 1025 needs to be evacuated. Auxiliary heater 1023 may be placed through the auxiliary heater port 1024 to provide extra direct electrical heating capacity if necessary.

Those skilled in the art will readily recognize, in light of the teachings of the present invention, that digital boilers according to embodiments of the present invention may vary widely in the size, shape and configuration of the boiler and of its individual components. As noted above, systems for heat recovery of cryptocurrency mining applications may be implemented in a multiplicity of suitable arrangements to satisfy various different system requirements and objectives. For example, without limitation, some embodiments may comprise multiple miner components. Other embodiments may house the mining components in a separate enclosure from the water tank components.

Highly integrated cryptocurrency miner heat recovery systems according to embodiments of the present invention can work independently in various residential and commercial circumstances. The water supply temperature achieved by such embodiments is typically high enough to meet the requirements of current codes/standards. The parameters of these embodiments including but not limited to size, volume, interface may be configured to be compatible with current products and could be considered as drop-in replacements of current products in some existing systems. It is contemplated that embodiments of the present invention have the capability to make profits from mining while simultaneously providing high-grade hot water or heat as a free byproduct as the miners can work in a stable and reliable manner due to the liquid cooling solution.

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3 rd parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing heat recovery systems configured to recover thermal energy from heat generating IT applications according to the present invention will be apparent to those skilled in the art. Various aspects of the invention have been described above by way of illustration, and the specific embodiments disclosed are not intended to limit the invention to the particular forms disclosed. The particular implementation of the heat recovery systems may vary depending upon the particular context or application. By way of example, and not limitation, the heat recovery systems described in the foregoing were principally directed to cryptocurrency mining implementations; however, similar techniques may instead be applied to other types of heat generating IT applications such as but not limited to server farms, mainframe computers or supercomputers, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A system, said system comprising:
a liquid cooling chassis, wherein said liquid cooling chassis comprises a miner and a dielectric fluid enclosure, said miner generating heat; and
a water tank kit, said water tank kit storing water;
wherein the heat generated from said miner is transferred to the water stored in said water tank kit, producing a heat source thereof.

2. The system of claim 1, wherein said water tank kit comprises a coil heating the water stored in said water tank kit.

3. The system of claim 2, wherein said dielectric fluid flows through said coil.

4. The system of claim 1, further comprises a pump circulating said dielectric fluid between said liquid cooling chassis and said water tank kit for transferring heat from said miner in said liquid cooling chassis to the water in said water tank kit.

5. The system of claim 1, further comprises a dry cooler, said dry cooler maintains a preset temperature of the water in said water tank kit.

6. The system of claim 1, further comprises at least one of:
a water replenishing kit; or
an open expansion tank kit, supplying water to said water tank kit.

7. The system of claim 1, further comprises hot water reservoirs storing the water heated in said water tank kit.

8. The system of claim 1, further comprises multiple liquid cooling chassis, wherein said dielectric fluid is distributed between said multiple cooling chassis based on a heat generated by a respective miner in each of said multiple liquid cooling chassis.

9. The system of claim 1, further includes a secondary fluid circle operating in one of the following modes:
as a secondary/auxiliary heat source to heat the water in said water tank kit; or
as a secondary/auxiliary heat sink to cool the water in said water tank kit.

10. The system of claim 1, wherein said miner is a cryptocurrency miner.

11. A system comprising:
means for generating heat;
means for absorbing said generated heat; and
means for transferring said generated heat to said heat absorbing means.

12. The system of claim 11, wherein said heat transferring means comprises pumping a dielectric fluid between said heat generating means and said heat absorbing means.

13. The system of claim 11, further comprises said dielectric fluid flowing in an enclosure of said heat generating means, wherein the heat from said heat generating means is transferred to said dielectric fluid.

14. The system of claim 11, further comprises said dielectric fluid flowing in a coil in said heat absorbing means, wherein said heat from said dielectric fluid is transferred to the absorbing means surrounding said coil.

15. The system of claim 11, further comprises a cooling means to maintain a preset temperature in said absorbing means.

16. The system of claim 11, further comprises a means to replenish said means for absorbing.

17. The system of claim 11, further comprises a means for storing heat absorbed by said absorption means.

18. A digital boiler system, said digital boiler system comprises:
a miner liquid cooling chassis, wherein said miner liquid cooling chassis comprises a miner within a dielectric fluid enclosure, said miner generates heat and transfers the heat to a dielectric fluid within said dielectric fluid enclosure;
a water tank kit, said water tank kit comprises a heating coil immersed in water, wherein said dielectric fluid flows through said heating coil to heat the water in said water tank;
a water replenishing kit, said water replenishing kit provides water to said water tank kit;
a dry cooler comprising a coil and a fan, said dry cooler maintains a preset temperature of the water in said water tank kit; and
a pump, said pump circulates said dielectric fluid between said liquid cooling chassis and said water tank kit to transfer the heat from said miner in said liquid cooling chassis to the water in said water tank kit.

19. The digital boiler system of claim 18, further comprises an open expansion tank kit, supplying water to said water tank kit.

20. The digital boiler system of claim 18, further comprises hot water reservoirs storing the water heated in said water tank kit.
